(19) United States
(12) Patent Application Publication
(10) Pub. No.: US 2012/0236699 A1
(43) Pub. Date: Sep. 20, 2012

(54) OPTICAL DISC RECORDING AND REPRODUCING SEMICONDUCTOR INTEGRATED CIRCUIT AND OPERATING METHOD THEREOF

(75) Inventors: Tomokazu Yokoyama, Kanagawa (JP); Misuzu Mochizuki, Yokohama (JP)

(73) Assignee: RENESAS ELECTRONICS CORPORATION

(21) Appl. No.: 13/411,586

(22) Filed: Mar. 4, 2012

(30) Foreign Application Priority Data
Mar. 18, 2011 (JP) 2011-060137

(51) Int. Cl. G11B 20/18; G11B 27/36

(52) U.S. Cl. 369/53.34; 369/53.35; G9B/20.046; G9B/27.052

(57) ABSTRACT

A semiconductor integrated circuit is equipped with a reproduction ECC circuit, a recording ECC circuit, a host interface circuit, and a memory control circuit. The memory control circuit includes an arbitration circuit and a count circuit. The arbitration circuit arbitrates ECC access with a priority order higher than the access of a host interface with a host apparatus. The count circuit counts the number of output times of the ECC request, and, when the count reaches a prescribed number, the count circuit generates a count termination signal. The arbitration circuit performs switching of priority orders to arbitrate the host with a priority order higher than that of ECC. The prescribed number corresponds to number of output times of the ECC access request necessary for accessing a semiconductor memory in relation to data of one ECC block or of an integral multiple of the one ECC block.

### CROSS-REFERENCE TO RELATED APPLICATION

The disclosure of Japanese Patent Application No. 2011-60137 filed on Mar. 18, 2011 including the specification, drawings and abstract is incorporated herein by reference in its entirety.

### BACKGROUND

The present invention relates to an optical disc recording and reproducing semiconductor integrated circuit and its operating method, in particular, to a technology effective for making it easy to respond to a special recording operation and a special reproduction operation.

In an optical disc recording and reproducing device capable of performing a reading operation (a reproduction operation) and a writing operation (a recording operation) of optical discs such as digital versatile disc (DVD) and blu-ray disc (BD), data read from a recording medium such as optical discs are temporarily stored in a large capacity semiconductor memory such as synchronous dynamic random access memory (SDRAM) and are subjected to processing such as error correction, and, furthermore, data after the error correction are written back to a memory such as SDRAM. When the memory such as SDRAM is accessed by a demodulation unit, an ECC decoder, a microprocessor and a host data transfer unit of an optical disc recording and reproducing device, an arbiter performs the access arbitration. There is a problem in which, when the access arbitration by the arbiter is determined by a priority sequence previously set and an ECC processing is set at the lowest rank of the priority sequence, in the case where a readout request occurs from other bus masters of a higher priority order, the ECC processing of a lower priority sequence is halted for a long time period.

To solve the problem, Japanese Patent Laid-Open No. 2001-75861 (Patent Document 1) describes that, by frequency-dividing a disc reproducing clock by a frequency-dividing counter and supplying a frequency-divided clock to an ECC decoder, when an interruption request from the ECC decoder is received by the arbiter, the arbiter allows the access request from the ECC decoder at the subsequent access allowance timing and pulls up the access right of the ECC decoder from the lowest rank to the highest rank.

Japanese Patent Laid-Open No. 2004-14088 (Patent Document 2) describes an ECC format for user data and management data of blu-ray disc (BD) as a high density disc, which allows information recording and information reproduction by using a laser having wavelength of 405 nm (a blue laser), and also describes long distance code (LDC) and burst indicator subcode (BID) as two error correction codes (ECCs).

### SUMMARY

Prior to the present invention, the present inventors engaged in the development of an optical disc recording and reproducing semiconductor integrated circuit capable of performing a writing operation (a recording operation) and a reading operation (a reproduction operation) of optical discs such as DVD and BD.

For the optical disc recording and reproducing semiconductor integrated circuit, not only a usual recording operation and a usual reproduction operation, but also special recording operations and special reproduction operations such as a read-after-write operation, a full recording and verify reproduction are required. The read-after-write operation is an operation in which recorded data are reproduced directly after performing writing of data to a memory medium and the reproduced data are compared with the record source data, and when both data do not coincide with each other, the writing is determined to be a failure and re-writing is performed. The full recording is an operation in which, when recording halt is performed in the middle of recording, a recording ECC circuit re-scrambles unrecorded scramble data and transfers re-scrambled data and parity to a memory such as an SDRAM. The verify reproduction is a reproduction operation of outputting the result of ECC check alone.

To examine an access arbitration system of a memory such as an SDRAM in the optical disc recording and reproducing semiconductor integrated circuit that requires special recording operations and special reproduction operations such as the read-after-write operation, the full recording and the verify reproduction as described above, prior to the present invention, the present inventors examined in detail the system described in Patent Document 1.

In the system described in Patent Document 1, in recording or reproducing a recording medium, the frequency-dividing counter frequency-divides a recording clock or a reproducing clock, and the frequency-dividing clock outputs interruption request for moving access request up to a higher rank. However, the examination by the present inventors prior to the present invention has clarified that there is a problem in which, when applying the system described in Patent Document 1 to the above-mentioned optical disc recording and reproducing semiconductor integrated circuit requiring the special recording operation and the special reproduction operation, a specific implementation of to what value the frequency division number of the frequency-dividing counter should be determined is indefinite.

The present invention has been achieved as the result of the examination as described above by the present inventors prior to the present invention.

Accordingly, an object of the present invention is to provide easy response to special recording operations and special reproduction operations, in an optical disc recording and reproducing semiconductor integrated circuit.

The other purposes and the new feature of the present invention will become clear from the description of the present specification and the accompanying diagrams.

The following explains briefly the outline of a typical invention among the inventions disclosed in the present application.

A representative embodiment of the present invention is an optical disc recording and reproducing semiconductor integrated circuit (LSI) that can be incorporated in an optical disc recording and reproducing device that reads information from an optical disc (11) to perform the reproduction operation, and that writes information on the optical disc to perform the recording operation.

The optical disc recording and reproducing semiconductor integrated circuit (LSI) includes a reproduction error correction processing circuit (18), a recording error correction processing circuit (17), a host interface circuit (19) connectable to a host apparatus (2), and a memory control circuit (20) connectable to a semiconductor memory (22).

The memory control circuit (20) includes an arbitration circuit (200) and a count circuit (202).

The arbitration circuit (200) arbitrates, on the basis of a preset priority order, an ECC access request for accessing the semiconductor memory (22) in relation to error correction processing of the reproduction error correction processing circuit (18) and the recording error correction processing circuit (17), and a host interface access request by which the host interface circuit (19) accesses the semiconductor memory (22) in relation to a host interface with the host apparatus (2)

On the basis of the preset priority order, the arbitration circuit (200) arbitrates the ECC access request with a priority order higher than that of the host interface access request.

To the count circuit (202), an operation mode signal in relation to the reproduction operation and the recording operation is supplied.

The count circuit counts the number of output times of the ECC access request output from the reproduction error correction processing circuit (18) and the recording error correction processing circuit (17).

In response to the fact that the number of output times of the ECC access request, counted by the count circuit coincides with a prescribed number of output times in an operation mode designated by the operation mode signal, the count circuit generates a count termination signal.

The prescribed number of output times corresponds to the number of output times of the ECC access request necessary for accessing the semiconductor memory in relation to data of one ECC block of the optical disc or of an integral multiple of the one ECC block.

In response to the count termination signal generated from the count circuit, the arbitration circuit performs switching from the preset priority order to the priority order of the access arbitration.

The characteristic is that the arbitration circuit (200) arbitrates the host interface access request with a priority order, higher than that of the ECC access request, in accordance with the priority order of the access arbitration after the switching (see FIG. 1).

The following will explain briefly the effect acquired by the typical invention among the inventions disclosed in the present application.

In accordance with the present invention, the response to special recording operations and special reproduction operations can be made easy.

### BRIEF DESCRIPTION OF THE DRAWINGS

FIG. 1 is a diagram showing a configuration of an optical disc recording and reproducing device 1 incorporating the optical disc recording and reproducing semiconductor integrated circuit LSI in accordance with Embodiment 1 of the present invention.

FIG. 2 is a diagram showing the configuration of one ECC block of an optical disc being a blu-ray disc (BD), relating to ECC processing of the reproduction ECC processing circuit 18 and the recording ECC processing circuit 17 incorporated in the optical disc recording and reproducing semiconductor integrated circuit LSI in accordance with Embodiment 1 of the present invention in FIG. 1.

FIG. 3 is a diagram showing the condition in which a plurality of ECC blocks is stored in a memory 22 of an SDRAM of the optical disc recording and reproducing device 1 incorporating the optical disc recording and reproducing semiconductor integrated circuit LSI in accordance with Embodiment 1 of the present invention in FIG. 1.

FIG. 4 is a diagram explaining the priority order of the access arbitration by an arbitration circuit 200 of the memory control circuit 20 incorporated in the optical disc recording and reproducing semiconductor integrated circuit LSI in accordance with Embodiment 1 of the present invention in FIG. 1.

FIG. 5 is a diagram explaining the switching of the priority order of the access arbitration in the arbitration circuit 200 of the memory control circuit 20 incorporated in the optical disc recording and reproducing semiconductor integrated circuit LSI in accordance with Embodiment 1 of the present invention in FIG. 1.

FIG. 6 is a diagram showing the number of times of access request for the memory 22 of an SDRAM necessary for the recording operation and the reproduction operation of one ECC block, when the optical disc recording and reproducing device 1 incorporating the optical disc recording and reproducing semiconductor integrated circuit LSI in accordance with Embodiment 1 of the present invention in FIG. 1 performs respective operations of full reproduction fulldec being general reproduction, verify reproduction verifydec being special reproduction, full recording fullenc being special recording, and parity-added recording parityenc being general recording.

FIG. 7 is a diagram showing a reproduction ECC processing time period signal, a recording ECC processing time period signal, various operation modes of reproduction operations and recording operations, and the number of output times of the ECC access request in one ECC block in the optical disc recording and reproducing semiconductor integrated circuit LSI in accordance with Embodiment 1 of the present invention in FIG. 1.

FIG. 8 is a diagram explaining a read-after-write operation being a special recording reproduction operation performed in the optical disc recording and reproducing semiconductor integrated circuit LSI in accordance with Embodiment 1 of the present invention in FIG. 1.

FIG. 9 is a diagram showing the configuration of another memory control circuit 20 incorporated in the optical disc recording and reproducing semiconductor integrated circuit LSI in accordance with Embodiment 2 of the present invention.

FIG. 10 is a diagram explaining operation of the optical disc recording and reproducing semiconductor integrated circuit LSI in accordance with Embodiment 2 of the present invention incorporating the other memory control circuit 20 in FIG. 9.

### DETAILED DESCRIPTION

### 1. Outline of Embodiments

First, an outline of representative embodiments of the invention disclosed in the present application will be explained. Reference numerals of the drawings referred with parentheses in the explanation of the outline about representative embodiments only exemplify one included in a general idea of constituent element to which the reference numeral is attached.

[1] A representative embodiment of the present invention is an optical disc recording and reproducing semiconductor integrated circuit (LSI) that can be incorporated in an optical disc recording and reproducing device performing reproduction operation by reading information from an optical disc (11) and performing recording operation by writing information on the optical disc.

The optical disc recording and reproducing semiconductor integrated circuit (LSI) includes a reproduction error correction processing circuit (18) for the reproduction operation, a recording error correction processing circuit (17) for the recording operation, a host interface circuit (19) connectable to a host apparatus (2), and a memory control circuit (20) connectable to a semiconductor memory (22).

The memory control circuit (20) includes an arbitration circuit (200) and a count circuit (202).

The arbitration circuit (200) is set to be capable of arbitrating, in accordance with a preset priority order, ECC access request for accessing the semiconductor memory (22) in relation to the error correction processing of the reproduction error correction processing circuit (18) and the recording error correction processing circuit (17), and host interface access request by which the host interface circuit (19) accesses the semiconductor memory (22) in relation to a host interface with the host apparatus (2).

In accordance with the preset priority order, the arbitration circuit (200) arbitrates the ECC access request with a priority order higher than that of the host interface access request.

To the count circuit (202), an operation mode signal related to the reproduction operation and the recording operation can be supplied.

The count circuit (202) counts the number of output times of the ECC access request that is output from the reproduction error correction processing circuit (18) and the recording error correction processing circuit (17).

In response to the fact that the number of output times of the ECC access request, counted by the count circuit (202) coincides with a prescribed number of output times in an operation mode designated by the operation mode signal, the count circuit (202) generates a count termination signal.

The prescribed number of output times corresponds to the number of output times of the ECC access request necessary for accessing the semiconductor memory in relation to data of one ECC block or integral multiple of the one ECC block of the optical disc.

In response to the count termination signal generated from the count circuit (202), the arbitration circuit (200) performs switching of the priority order of the access arbitration from the preset priority order.

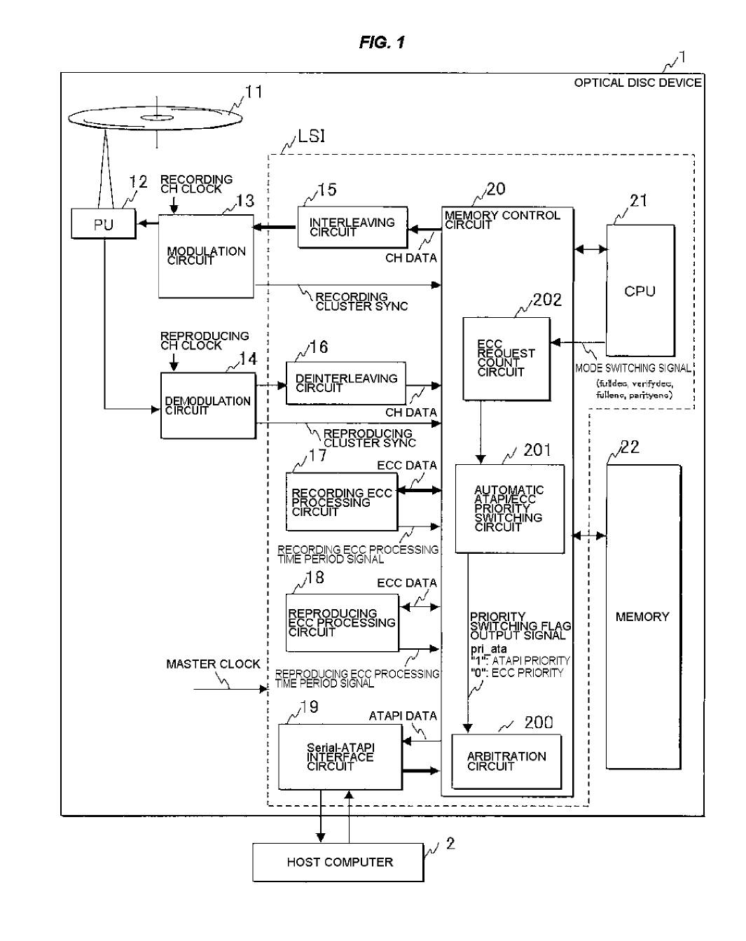

The characteristic is that the arbitration circuit (200) arbitrates the host interface access request with a priority order higher than that of the ECC access request, in accordance with the priority order of the access arbitration after the switching (see FIG. 1).

In accordance with the embodiment, the response to special recording operations and special reproduction operations can be made easy.

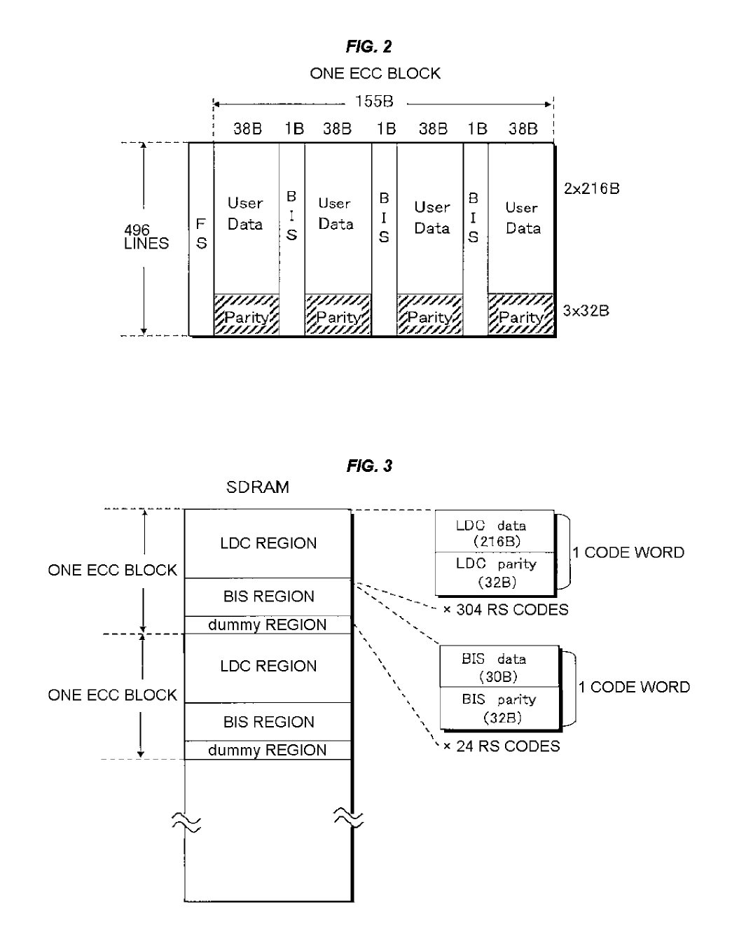

A favorable embodiment is characterized in that the one ECC block is the smallest unit of the error correction processing of the reproduction error correction processing circuit and the recording error correction processing circuit (see FIG. 2).

In another favorable embodiment, by supplying a reproduction signal of a pickup (12) incorporated in the optical disc recording and reproducing device to demodulation circuit (14) incorporated in the optical disc recording and reproducing device, the supply of reproduction data generated from the demodulation circuit (14) to the reproduction error correction processing circuit (18) is made possible.

The reproduction error correction processing circuit (18) is made capable of performing reproduction error correction processing on the reproduction data generated from the demodulation circuit (14).

The recording error correction processing circuit (17) is characterized in that it is made capable of performing recording error correction processing on recording information read from the semiconductor memory (22) via the memory control circuit (20), and that record data after the recording error correction processing are made capable of being supplied to the pickup via a modulation circuit (13) incorporated in the optical disc recording and reproducing device.

In a further another favorable embodiment, the count circuit (202) receives, at the time of the reproduction operation, a reproduction cluster synchronization signal (SYNC) indicating the head of the one ECC block from the demodulation circuit (14).

The count circuit (202) receives, at the time of the recording operation, a recording cluster synchronization signal (SYNC) indicating the head of the one ECC block from the modulation circuit (13).

A characteristic is that the reset of the number of output times of the ECC access request, counted by the count circuit to the count initial value is made possible by a synchronization signal supplied at an early stage to the count circuit of the reproduction cluster synchronization signal and the recording cluster synchronization signal.

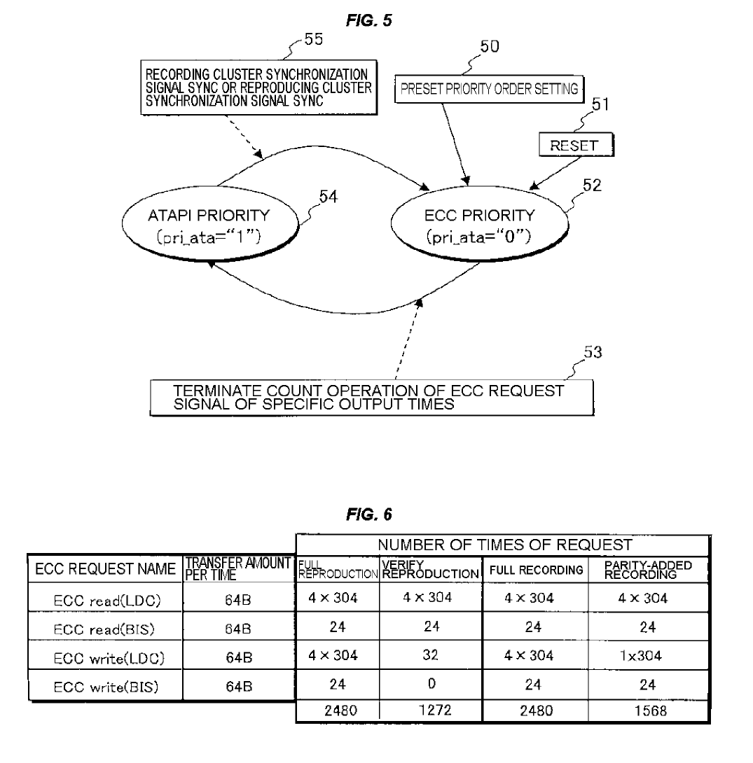

In a more favorable embodiment, the arbitration circuit (200) is characterized by returning to the preset priority order from the priority order of the access arbitration after the switching, in response to the fact that the count circuit is reset by the synchronization signal supplied at an early stage (see FIG. 5).

The optical disc recording and reproducing semiconductor integrated circuit in accordance with another more favorable embodiment further includes a central processing unit (21) connected to the memory control circuit (20).

The central processing unit is characterized by being made capable of supplying the operation mode signal designating general reproduction (fulldec) and special reproduction (verifydec) as the reproduction operation and general recording (parityenc) and special recording (fullenc) as the recording operation, to the count circuit (202).

In further another favorable embodiment, a characteristic is that the arbitration circuit (200) is made capable of arbitrating channel access request (CH) regarding the reproduction data generated from the demodulation circuit (14) and the record data supplied to the modulation circuit (13), and CPU access request (CPU) from the central processing unit (21).

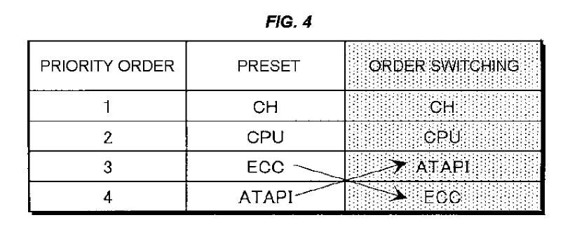

Another more favorable embodiment is characterized in that, in either of the preset priority order and the priority order of the access arbitration after the switching, the arbitration circuit sets the channel access request at the first of both priority orders, that the arbitration circuit sets the CPU access request at the second of the both priority orders, and that the arbitration circuit sets the ECC request and the host interface access request at the third or lower of the both priority orders (see FIG. 4).

In a specific embodiment, a characteristic is that the semiconductor memory (22) is a dynamic random access memory (see FIG. 1).

The most specific embodiment is characterized in that a semiconductor chip of the optical disc recording and reproducing semiconductor integrated circuit (LSI), and a semiconductor chip of the dynamic random access memory as the semiconductor memory are incorporated in a single sealing package (see FIG. 1).

[2] A representative embodiment of the present invention from another viewpoint is an operating method of an optical disc recording and reproducing semiconductor integrated circuit (LSI) that can be incorporated in an optical disc recording and reproducing device performing a reproduction operation by reading information from the optical disc (11) and performing recording operation by writing information on the optical disc.

The optical disc recording and reproducing semiconductor integrated circuit (LSI) includes the reproduction error correction processing circuit (18) for the reproduction operation, the recording error correction processing circuit (17) for the recording operation, the host interface circuit (19) connectable to the host apparatus (2), and the memory control circuit (20) connectable to the semiconductor memory (22).

The memory control circuit (20) includes the arbitration circuit (200) and the count circuit (202).

The arbitration circuit (200) is set to be capable of arbitrating between ECC access request for accessing the semiconductor memory (22) in relation to error correction processing of the reproduction error correction processing circuit (18) and the recording error correction processing circuit (17), and host interface access request by which the host interface circuit (19) accesses the semiconductor memory (22) in relation to a host interface with the host apparatus (2), by a preset priority order.

In accordance with the preset priority order, the arbitration circuit (200) arbitrates the ECC access request with a priority order higher than that of the host interface access request.

To the count circuit (202), an operation mode signal in relation to the reproduction operation and the recording operation can be supplied.

The count circuit (202) counts the number of output times of the ECC access request that is output from the reproduction error correction processing circuit (18) and the recording error correction processing circuit (17).

In response to the fact that the number of output times of the ECC access request, counted by the count circuit (202) coincides with a prescribed number of output times in an operation mode designated by the operation mode signal, the count circuit (202) generates a count termination signal.

The prescribed number of output times corresponds to the number of output times of the ECC access request necessary for accessing the semiconductor memory in relation to data of one ECC block of the optical disc or of an integral multiple of the one ECC block.

In response to the count termination signal generated from the count circuit (202), the arbitration circuit (200) performs switching from the preset priority order to the priority order of the access arbitration.

The characteristic is that the arbitration circuit (200) arbitrates the host interface access request with a priority order higher than that of the ECC access request, in accordance with the priority order of the access arbitration after the switching (see FIG. 1).

In accordance with the embodiment, the response to special recording operations and special reproduction operations can be made easy.

### 2. Detail of Embodiments

Next, embodiments will be described in more detail. Meanwhile, in all drawings for explaining the best mode for performing the invention, to apart having the same function as that in the above-mentioned drawings, the same reference numeral is given and the repeated explanation is omitted.

### Embodiment 1

### Configuration of an Optical Disc Recording and Reproducing Device

FIG. 1 is a diagram showing a configuration of an optical disc recording and reproducing device 1 incorporating the optical disc recording and reproducing semiconductor integrated circuit LSI in accordance with Embodiment 1 of the present invention.

As shown in FIG. 1, the optical disc recording and reproducing device 1 is constituted of the optical disc recording and reproducing semiconductor integrated circuit LSI in accordance with Embodiment 1 of the present invention, an optical head pickup 12, a modulation circuit 13, a demodulation circuit 14 and a semiconductor memory 22 of an SDRAM. The optical disc recording and reproducing device 1 performs reproduction operation by reading reading data from the optical disc 11 such as a DVD or a BD and supplying the same to a host computer 2, and performs recording operation by writing writing data from the host computer 2 on the detachable optical disc 11.

The optical disc recording and reproducing semiconductor integrated circuit LSI is constituted of an interleaving circuit 15, a deinterleaving circuit 16, the recording ECC processing circuit 17, the reproduction ECC processing circuit 18, a Serial-ATAPI interface circuit 19, the memory control circuit 20, and the central processing unit (CPU) 21. The memory control circuit 20 includes the arbitration circuit 200, the automatic ATAPI/ECC priority switching circuit 201, and the ECC request count circuit 202. To the optical disc recording and reproducing semiconductor integrated circuit LSI, a master clock generated from a clock generator (not shown) is supplied. ATAPI is an abbreviated denotation of an “Advanced Technology Attachment Packet Interface.” In particular, the optical disc recording and reproducing semiconductor integrated circuit LSI and the semiconductor memory 22 of an SDRAM can be formed into a shape of a hybrid semiconductor integrated circuit called a system in package (SIP) or a multi chip module (MCM). A semiconductor chip of the semiconductor memory 22 of an SDRAM can be incorporated inside a resin sealing package incorporating a semiconductor chip of the optical disc recording and reproducing semiconductor integrated circuit LSI.

The detachable optical disc 11 is held by a spindle motor (not shown) to rotate. The optical head pickup 12 is constituted of a semiconductor laser emitting laser light performing recording and reproduction of information, an optical lens forming the laser light from the semiconductor laser into a light spot on the surface of the optical disc 11, and a light detector for performing a light spot control such as reproduction of information, automatic focusing and tracking using light reflected from the optical disc 11, and performs reading operation (reproduction operation) of information from the optical disc 11 while performing writing operation (recording operation) of information on the optical disc 11. By connecting the optical disc recording and reproducing device 1 with the host computer 2, commands and information data supplied from the host computer 2 are supplied to the central processing unit (CPU) 21, and the central processing unit (CPU) 21 controls recording operation of the information, reproduction operation of the information, and seeking operation of the pickup 12.

### <<Reproduction Operation>>

The reproduction operation is performed by instructing reproduction start to the central processing unit (CPU) 21 from the host computer 2. The reproduction signal from the optical head pickup 12 is reproduced via the demodulation circuit 14 extracting data of the optical disc 11, descrambling circuit (not shown), the deinterleaving circuit 16, and the reproduction ECC processing circuit 18. A large volume of data reproduced from the optical disc 11 is stored temporarily in the memory 22 of an SDRAM by the memory control circuit 20.

Channel reproduction data generated by deinterleaving a demodulation output signal of the demodulation circuit 14 by the deinterleaving circuit 16 and by descrambling the same by a descrambling circuit (not shown) are stored in the memory 22 of the an SDRAM via the memory control circuit 20. Reproduction data read from the memory 22 of the SDRAM via the memory control circuit 20 are subjected to error correction processing by the reproduction ECC processing circuit 18, and the reproduction data after the error correction processing are stored again in the memory 22 of the SDRAM via the memory control circuit 20. The reproduction data stored in the memory 22 of the SDRAM are output to the host computer 2 via the Serial-ATAPI interface circuit 19. In the reproduction operation, the semiconductor laser of the optical head pickup 12 emits laser light of a comparatively low output power.

### <<Recording Operation>>

The recording operation is performed by instructing recording start from the host computer 2 to the central processing unit (CPU) 21. The record data supplied from the host computer 2 via the Serial-ATAPI interface circuit 19 are converted to NRZI record data by a recording ECC processing circuit 17, a scrambling circuit (not shown), the interleaving circuit 15, and the modulation circuit 13. NRZI means “non return to zero inversion,” that is, NRZ of negative logic. A large volume of record data is stored temporarily in the memory 22 of the SDRAM by the memory control circuit 20. At that time, channel record data interleaved by the interleaving circuit 15 are stored in the memory 22 of the SDRAM via the memory control circuit 20. Record data read from the memory 22 of the SDRAM via the memory control circuit 20 are subjected to recording ECC processing in the recording ECC processing circuit 17 and the record data after the recording ECC processing are stored in the memory 22 of the SDRAM via the memory control circuit 20. In response to the NRZI record data thus generated, the optical head pickup 12 irradiates the optical disc 11 with writing laser light, and thus recording operation is performed.

### <<Memory Control Circuit>>

The memory control circuit 20 includes the arbitration circuit 200, the automatic ATAPI/ECC priority switching circuit 201, and the ECC request count circuit 202.

The arbitration circuit 200 functions as an arbiter that arbitrates among a plurality of accesses from the modulation circuit 13, the demodulation circuit 14, the recording ECC processing circuit 17, the reproduction ECC processing circuit 18, the Serial-ATAPI interface circuit 19 and the central processing unit (CPU) 21, as a plurality of bus masters requiring an access to the memory 22 of the SDRAM. The access arbitration by the arbitration circuit 200 is usually determined by a preset priority order.

In the usual access arbitration determined by the preset priority order, the ATAPI access request from the Serial-ATAPI interface circuit 19 is set at the lowest rank of the priority order, and, further, ECC access requests from the recording ECC processing circuit 17 and the reproduction ECC processing circuit 18 are set at an order higher by one than the priority order at the lowest rank. However, when a priority switching flag output signal “1” designating the priority of the ATAPI access request is supplied to the arbitration circuit 200 from the automatic ATAPI/ECC priority switching circuit 201, in the access arbitration by the arbitration circuit 200, the switching is performed between the priority order at the lowest rank and the order higher by one than the lowest rank. The ECC access request is set at the lowest of the priority order, and the ATAPI access request is set at the order higher by one than the lowest order. But, in the access arbitration by the arbitration circuit 200 at the subsequent access cycle of the memory 22 of the SDRAM, the priority order is returned to the usual preset one. Therefore, the ATAPI access request is set at the lowest of the priority order; and the ECC access request is set at the order higher by one than the lowest priority order. The start of the access cycle of the memory 22 of the SDRAM in which the priority order is returned to the usual preset one in the access arbitration is designated by a signal supplied in an early stage to the ECC request count circuit 202 of a reproduction cluster synchronization signal SYNC and a recording cluster synchronization signal SYNC to be described below.

In the reproduction operation, the ECC request count circuit 202 receives a reproduction ECC processing time period signal from the reproduction ECC processing circuit 18. Moreover, in the recording operation, the ECC request count circuit 202 receives the recording ECC processing time period signal from the recording ECC processing circuit 17. Further, in the reproduction operation, the ECC request count circuit 202 receives the reproduction cluster synchronization signal SYNC indicating the head of one ECC block from the demodulation circuit 14. In the recording operation, the ECC request count circuit 202 receives the recording cluster synchronization signal SYNC indicating the head of one ECC block from the modulation circuit 13.

The ECC request count circuit 202 counts the number of times of ECC request signal output that is output from the reproduction ECC processing circuit 18 and the recording ECC processing circuit 17. The ECC request signal is a demand signal for data writing access or data reading access to the memory 22 of the SDRAM in relation to the ECC processing of the reproduction ECC processing circuit 18 and the recording ECC processing circuit 17. The counter value of the ECC request count circuit 202 is reset by the reproduction cluster synchronization signal SYNC from the demodulation circuit 14 and the recording cluster synchronization signal SYNC from the modulation circuit 13 to be returned to the count initial value “0.” The ECC request count circuit 202 responds to a recording/reproduction operation mode switching signal supplied from the central processing unit (CPU) 21, and, in various operation modes of the recording operation and the reproduction operation, performs the count operation of the number of times of ECC request signal output different among respective operation modes. The recording/reproduction operation mode switching signal supplied from the central processing unit (CPU) 21 designates a full reproduction fulldec being a general reproduction, a verify reproduction verifydec being a special reproduction, a full recording fullenc being a special recording, and a parity-added recording parityenc being a general recording. When terminating the count operation of the ECC request signal having the number of output times specific to respective operation modes, the ECC request count circuit 202 outputs a count termination signal. The specific number of output times of the ECC request signal, with which the ECC request count circuit 202 outputs the count termination signal in respective operation modes of the recording operation and the reproduction operation, corresponds to the number of times of the access request to the memory 22 of the SDRAM necessary for the recording operation and the reproduction operation of one ECC block.

In response to the count termination signal supplied from the ECC request count circuit 202, the automatic ATAPI/ECC priority switching circuit 201 supplies a priority switching flag output signal “1” that gives priority to the ATAPI access request to the arbitration circuit 200. Accordingly, in the access arbitration by the arbitration circuit 200, since switching is performed between the lowest priority order and the order higher by one than the lowest, the ECC access request is set at the lowest priority order and the ATAPI access request is set at the order higher by one than the lowest priority order.

### <<One ECC Block>>

FIG. 2 is a diagram showing the configuration of one ECC block of an optical disc being a blu-ray disc (BD), related to ECC processing of the reproduction ECC processing circuit 18 and the recording ECC processing circuit 17, incorporated in the optical disc recording and reproducing semiconductor integrated circuit LSI in accordance with Embodiment 1 of the present invention in FIG. 1.

One ECC block in FIG. 2 is the smallest unit of the error correction processing by error correction code (ECC). Accordingly, if one ECC block in FIG. 2 is divided into a plurality of sub blocks, the error correction processing by ECC becomes impossible.

As described in Patent Document 2, in one ECC block of a blu-ray disc (BD) in FIG. 2, user data having a data size of 64 KB (=1 sector 2048 B×32 sectors) are stored. The user data of 64 KB are protected by a code referred to as long distance code (LDC) and a code referred to as burst indicator subcode (BIS).

As shown in FIG. 2, one ECC block includes 496 lines (496 frames) of 155 B frames in total including four 38 B user data and three 1 B BIS. On the most left side of one ECC block, a frame sync (frame synchronization signal) FS indicating the head of the frame of 155 B in total is allocated.

To user data of 1 sector 2048 B, a 4 B error detection code (EDC) is added and LDC is encoded for 32 sectors. LDC is constituted of 304 code words, and is constituted of a 216 B information symbol and a 32 B parity symbol. Accordingly, LDC is a read solomon (RS) code of RS (248, 216, 33), which includes code length 248, data 216, distance 33, and, is capable of being corrected up to 16 symbols.

Management data such as address information of record data are ECC encoded by using BIS (Burst Indicator Subcode). BIS is constituted of a 30 B information symbol and a 32 B parity symbol. Accordingly, BIS is a read solomon (RS) code of RS (62, 30, and 33), which includes code length 62, data 30, and distance 33. The information symbol of BIS is a symbol including address information of record data, and a read solomon (RS) code separate from user data is prepared for correcting the error of address information of record data. Accordingly, it becomes possible to adopt a method for performing the correction while identifying, in advance, the position of a symbol supposed to be erroneous user data on the basis of the correction result of BIS, being called erasure correction. When the identification of the position coincides with the erroneous symbol, it is possible to be corrected up to 32 symbols.

### <<SDRAM>>

FIG. 3 is a diagram showing the condition in which a plurality of ECC blocks is stored in a memory 22 of an SDRAM of the optical disc recording and reproducing device 1 incorporating the optical disc recording and reproducing semiconductor integrated circuit LSI in accordance with Embodiment 1 of the present invention in FIG. 1. Each ECC block of the plurality of ECC blocks includes an LDC region, a BIS region, and a dummy.

In the LDC region, 304 code words including LDC data of a 216 B information symbol and LDC parity of a 32 B parity symbol are stored.

In the BIS region, 24 code words including BIS data of a 30 B information symbol and BIS parity of a 32 B parity symbol are stored.

In the dummy, information of a status and a monitor is stored, and furthermore, information necessary when makers and design companies of optical disc recording and reproducing devices develop a firmware of the optical disc recording and reproducing device 1 is stored.

### <<Priority Order of Access Arbitration>>

FIG. 4 is a diagram explaining the priority order of the access arbitration by an arbitration circuit 200 of the memory control circuit 20 incorporated in the optical disc recording and reproducing semiconductor integrated circuit LSI in accordance with Embodiment 1 of the present invention in FIG. 1.

On the left side in FIG. 4, the order of the priority is shown, at the middle in FIG. 4, the preset priority order is shown, and on the right side in FIG. 4, there is shown the priority order when the switching of the priority order of the access arbitration by the arbitration circuit 200 has been performed by supplying the priority switching flag output signal “1” designating the priority of ATAPI access request to the arbitration circuit 200 from the automatic ATAPI/ECC priority switching circuit 201.

In FIG. 4, first, CH shows the channel access request to the memory 22 of the SDRAM, regarding channel record data supplied to the modulation circuit 13 and the interleaving circuit 15, and channel reproduction data supplied from the demodulation circuit 14 and the deinterleaving circuit 16. Moreover, in FIG. 4, the CPU shows CPU access request by the central processing unit (CPU) 21 to the memory 22 of the SDRAM, the ECC shows ECC access request by the recording ECC processing circuit 17 and the reproduction ECC processing circuit 18 to the memory 22 of the SDRAM, and the ATAPI shows ATAPI access request by the Serial-ATAPI interface circuit 19 to the memory 22 of the SDRAM.

In the preset priority order at the middle in FIG. 4, to set the reading operation and the writing operation of the optical disc 11 to be the top priority, the channel access request CH is set at the first being the highest rank of the priority order. Subsequently, the CPU access request is set at the second of the priority order, because the central processing unit (CPU) 21 needs to respond quickly to the interruption request from the host computer 2. Further subsequently, the ECC access request by the recording ECC processing circuit 17 and the reproduction ECC processing circuit 18 regarding the ECC processing is set at the third of the priority order. Finally, the ATAPI access request by the Serial-ATAPI interface circuit 19 regarding the transfer of host data is set at the fourth being the lowest priority order.

In the priority after the priority switching on the right in FIG. 4, the ECC access request is set at the fourth being the lowest priority order, and the ATAPI access request by the Serial-ATAPI interface circuit 19 regarding the host data transfer is set at the third of the priority order.

### <<Switching of Priority Order in Access Arbitration>>

FIG. 5 is a diagram explaining the switching of the priority order of the access arbitration in the arbitration circuit 200 of the memory control circuit 20 incorporated in the optical disc recording and reproducing semiconductor integrated circuit LSI in accordance with Embodiment 1 of the present invention in FIG. 1.

As shown in FIG. 5, in the preset priority order 50 at the middle in FIG. 4, or in the reset state 51 in which the optical disc recording and reproducing device 1 has been system-reset in accordance with Embodiment 1 of the present invention in FIG. 1, the state is set to be a state 52 of ECC priority. In the state 52 of the ECC priority, the ECC access request is set at the third of the priority order, and the ATAPI access request is set at the fourth of the priority order being the lowest.

In the state 52 of the ECC priority, when the ECC request count circuit 202 terminates the count operation of the ECC request signal of the number of output times specific to various operation modes of the recording operation and the reproduction operation and outputs the count termination signal (state 53), the switching of the priority order of the access arbitration is performed in the arbitration circuit 200. Accordingly, the access arbitration in the arbitration circuit 200 transitions from the state 52 of the ECC priority to the state 54 of the ATAPI priority. In the state 54 of the ATAPI priority, the ECC access request is set at the fourth of the priority order being the lowest, and the ATAPI access request is set at the third of the priority order.

In response to a signal supplied at an early stage of the recording cluster synchronization signal SYNC from the modulation circuit 13 or the reproduction cluster synchronization signal SYNC from the demodulation circuit 14 in the state 54 of the ATAPI priority (state 55), the state 54 of the ATAPI priority is returned to the state 52 of the ECC priority. The access arbitration by the arbitration circuit 200 is returned to the usual preset priority order, and thus the ATAPI access request is set at the lowest priority order, and the ECC access request is set at the order higher by one than the lowest priority order.

### <<Number of Times of Access Request to SDRAM>>

FIG. 6 is a diagram showing the number of times of access request for the memory 22 of an SDRAM necessary for the recording operation and the reproduction operation of one ECC block, when the optical disc recording and reproducing device 1 incorporating the optical disc recording and reproducing semiconductor integrated circuit LSI in accordance with Embodiment 1 of the present invention in FIG. 1 performs operations of full reproduction fulldec being general reproduction, verify reproduction verifydec being special reproduction, full recording fullenc being special recording, and parity-added recording parityenc being general recording.

Four columns on the right side in FIG. 6 show the number of times of the access request of the full reproduction fulldec being general reproduction, the number of times of the access request of the verify reproduction verifydec being special reproduction, the number of times of the access request of the full recording fullenc being special recording, and the number of times of the access request of the parity-added recording parityenc being general recording.

Two columns on the left side in FIG. 6 show four kinds of ECC access request names and a data transfer amount per time of requests. The first line of two columns on the left side in FIG. 6 show ECC read (LDC) being ECC access request for reading data in the LDC region of the memory 22 of the SDRAM in FIG. 3 and 64 B being a data transfer amount per time. The second line of two columns on the left side in FIG. 6 shows ECC read (BIS) being ECC access request for reading data in the BIS region of the memory 22 of the SDRAM in FIG. 3 and 64 B being a data transfer amount per time. The third line of two columns on the left side in FIG. 6 shows ECC write (LDC) being ECC access request for writing data in the LDC region of the memory 22 of the SDRAM in FIG. 3 and 64 B being a data transfer amount per time. The fourth line of two columns on the left side in FIG. 6 shows ECC write (BIS) being ECC access request for writing data in the BIS region of the memory 22 of the SDRAM in FIG. 3 and 64 B being a data transfer amount per time.

### <<Full Reproduction>>

The full reproduction fulldec being general reproduction is required to reproduce user data of one ECC block and management data such as address information of record data. For that purpose, it is necessary to read one ECC block having the structure in FIG. 2 from the optical disc 11 being a blu-ray disc (BD), and to write data in the LDC region and the BIS region of the memory 22 of the SDRAM in FIG. 3. After that, to transfer data stored in the LDC region and the BIS region of the memory 22 of the SDRAM in FIG. 3 to the reproduction ECC processing circuit 18, it is necessary to read the data stored in the LDC region and the BIS region of the memory 22 of the SDRAM. For that purpose, two kinds of ECC access request, which are ECC read (LDC) and ECC read (BIS), are used, and the ECC access request ECC read (LDC) is output from the reproduction ECC processing circuit 18 to the ECC request count circuit 202 in 4×304 times, and the ECC access request ECC read (BIS) is output from the reproduction ECC processing circuit 18 to the ECC request count circuit 202 in 24 times. Furthermore, after that, it is necessary to write data of error correction processing result having been subjected to the error correction processing by the reproduction ECC processing circuit 18 in the LDC region and the BIS region of the memory 22 of the SDRAM in FIG. 3. For that purpose, two kinds of ECC access request, ECC write (LDC) and ECC write (BIS) are used, and the ECC access request ECC write (LDC) is output from the reproduction ECC processing circuit 18 to the ECC request count circuit 202 in 4×304 times, and the ECC access request ECC write (BIS) is output from the reproduction ECC processing circuit 18 to the ECC request count circuit 202 in 24 times.

Accordingly, in the full reproduction fulldec being general reproduction, the total number of output times of the ECC access request that is output from the reproduction ECC processing circuit 18 to the ECC request count circuit 202 is 2480. The recording/reproduction operation mode switching signal supplied from the central processing unit 21 shows the full reproduction fulldec, and in response to the recording/reproduction operation mode switching signal, the ECC request count circuit 202 terminates the count operation and outputs a count termination output signal when the total number of output times of the ECC access request that is output from the reproduction ECC processing circuit 18 reaches 2480.

Then, in response to the count termination signal supplied from the ECC request count circuit 202, the automatic ATAPI/ECC priority switching circuit 201 supplies a priority switching flag output signal “1” designating the priority of the ATAPI access request, to the arbitration circuit 200. Accordingly, in the access arbitration by the arbitration circuit 200, the switching is performed between the lowest priority order and the order higher by one than the lowest, and thus the ECC access request is set at the lowest priority order and the ATAPI access request is set at the order higher by one than the lowest. However, in response to the reproduction cluster synchronization signal SYNC output subsequently from the demodulation circuit 14, because the access arbitration by the arbitration circuit 200 is returned to a usual preset priority order, the state 54 of ATAPI priority is returned to the state 52 of ECC priority.

### <<Verify Reproduction>>

The verify reproduction verifydec being special reproduction is a reproduction operation for verifying whether or not there is an error in user data recorded in the optical disc 11. Also in the verify reproduction verifydec of special reproduction, it is necessary to reproduce user data of one ECC block and management data such as address information of record data. For that purpose, it is necessary to read one ECC block having the structure shown in FIG. 2 from the optical disc 11 being a blu-ray disc (BD), and to write the data in the LDC region and the BIS region of the memory 22 of the SDRAM in FIG. 3. After that, to transfer the data stored in the LDC region and the BIS region of the memory 22 of the SDRAM in FIG. 3 to the reproduction ECC processing circuit 18, it is necessary to read the data stored in the LDC region and the BIS region of the memory 22 of the SDRAM in FIG. 3. For that purpose, two kinds of ECC access request, which are ECC read (LDC) and ECC read (BIS), are used, and the ECC access request ECC read (LDC) is output in 4×304 times from the reproduction ECC processing circuit 18 to the ECC request count circuit 202, and the ECC access request ECC read (BIS) is output in 24 times from the reproduction ECC processing circuit 18 to the ECC request count circuit 202. Furthermore, after that, whether or not there is an error in user data recorded in the optical disc 11 is determined, from the result of error correction processing having been subjected to error correction processing by the reproduction ECC processing circuit 18. It is necessary to write the determination result of the presence or absence of an error of user data in another LDC region of the memory 22 of the SDRAM in FIG. 3. For that purpose, the ECC access request ECC write (LDC) is used, and the ECC access request ECC write (LDC) is output in 32 times from the reproduction ECC processing circuit 18 to the ECC request count circuit 202.

Accordingly, in the verify reproduction verifydec being special reproduction, the total number of output times of the ECC access request that is output from the reproduction ECC processing circuit 18 to the ECC request count circuit 202 becomes 1272. The recording/reproduction operation mode switching signal supplied from the central processing unit 21 shows the verify reproduction verifydec, and in response to the recording/reproduction operation mode switching signal, the ECC request count circuit 202 terminates the count operation and outputs the count termination output signal, when the total number of output times of the ECC access request that is output from the reproduction ECC processing circuit 18 reaches 1272.

Then, in response to the count termination signal supplied from the ECC request count circuit 202, the automatic ATAPI/ECC priority switching circuit 201 supplies the priority switching flag output signal “1” designating the priority of the ATAPI access request, to the arbitration circuit 200. Accordingly, in the access arbitration by the arbitration circuit 200, the switching is performed between the lowest priority order and the order higher than the lowest by one, and thus the ECC access request is set at the lowest, and the ATAPI access request is set at the order higher by one than the lowest. However, in response to the reproduction cluster synchronization signal SYNC output subsequently from the demodulation circuit 14, because the access arbitration by the arbitration circuit 200 is returned to the usual preset priority order, the state 54 of the ATAPI priority is returned to the state 52 of the ECC priority.

### <<Full Recording>>

The full recording fullenc being special recording is an operation in which, when recording halt is performed in the middle of the recording, the recording ECC processing circuit 17 rescrambles unrecorded scramble data and transfers rescrambled data and parity to the memory 22 of the SDRAM. For that purpose, it is necessary to read data unrecorded on the optical disc 11 from the LDC region and the BIS region of the memory 22 of the SDRAM in FIG. 3, and to transfer the data to the recording ECC processing circuit 17. Therefore, two kinds of ECC access request, which are ECC read (LDC) and ECC read (BIS), are used, and the ECC access request ECC read (LDC) is output 4×304 times from the recording ECC processing circuit 17 to the ECC request count circuit 202 and the ECC access request ECC read (BIS) is output 24 times from the recording ECC processing circuit 17 to the ECC request count circuit 202. Furthermore, after that, it is necessary to write user data and management data having been rescrambled by the recording ECC processing circuit 17 in the LDC region and the BIS region in the memory 22 of the SDRAM in FIG. 3. For that purpose, two kinds of ECC access request, which are ECC write (LDC) and ECC write (BIS), are used, and the ECC access request ECC write (LDC) is output 4×304 times from the recording ECC processing circuit 17 to the ECC request count circuit 202 and the ECC access request ECC write (BIS) is output 24 times from the recording ECC processing circuit 17 to the ECC request count circuit 202.

Accordingly, in the full recording fullenc being special recording, the total number of output times of the ECC access request that is output from the recording ECC processing circuit 17 to the ECC request count circuit 202 becomes 2480. The recording/reproduction operation mode switching signal supplied from the central processing unit 21 shows the full recording fullenc, and in response to the recording/reproduction operation mode switching signal, the ECC request count circuit 202 terminates the count operation and outputs the count termination output signal, when the total number of output times of the ECC access request that is output from the recording ECC processing circuit 17 reaches 2480.

Then, in response to the count termination signal supplied from the ECC request count circuit 202, the automatic ATAPI/ECC priority switching circuit 201 supplies priority switching flag output signal “1” designating the priority of the ATAPI access request, to the arbitration circuit 200. Accordingly, in the access arbitration by the arbitration circuit 200, switching is performed between the lowest priority order and the order higher by one than the lowest, and thus the ECC access request is set at the lowest priority order, and the ATAPI access request is set at the order higher by one than the lowest priority order. However, in response to the recording cluster synchronization signal SYNC output subsequently from the modulation circuit 13, because the access arbitration by the arbitration circuit 200 is returned to a usual preset priority order, the state 54 of the ATAPI priority is returned to the state 52 of the ECC priority.

### <<Parity-Added Recording>>

In parity-added recording parityenc being general recording, the memory control circuit 20 performs scrambling when the host computer 2 transfers writing data to the memory 22 of the SDRAM. The recording ECC processing circuit 17 reads the scrambled data and transfers only the parity of user data and management data to the memory 22 of the SDRAM. For that purpose, first, it is necessary to write writing data in the LDC region and the BIS region of the memory 22 of the SDRAM in FIG. 3. After that, to transfer the data stored in the LDC region and the BIS region of the memory 22 of the SDRAM shown in FIG. 3 to the recording ECC processing circuit 17, it is necessary to read the data stored in the LDC region and the BIS region of the memory 22 of the SDRAM in FIG. 3. For that purpose, two kinds of ECC access request, which are ECC read (LDC) and ECC read (BIS), are used, and the ECC access request ECC read (LDC) is output 4×304 times from the recording ECC processing circuit 17 to the ECC request count circuit 202, and the ECC access request ECC read (BIS) is output 24 times from the recording ECC processing circuit 17 to the ECC request count circuit 202. After that, it is necessary to write the parity of the user data rescrambled by the recording ECC processing circuit 17 and management data in the LDC region and the BIS region of the memory 22 of the SDRAM in FIG. 3. The parity of the user data is a parity Parity allocated in the lower part of four user data User Data of one ECC block in FIG. 2. For that purpose, two kinds of ECC access request, which are ECC write (LDC) and ECC write (BIS), are used, and the ECC access request ECC write (LDC) is output 1×304 times from the recording ECC processing circuit 17 to the ECC request count circuit 202, and the ECC access request ECC write (BIS) is output 24 times from the recording ECC processing circuit 17 to the ECC request count circuit 202.

Accordingly, in the general parity-added recording parityenc, the total number of output times of the ECC access request that is output from the recording ECC processing circuit 17 to the ECC request count circuit 202 becomes 1568. The recording/reproduction operation mode switching signal supplied from the central processing unit 21 shows the parity-added recording parityenc, and in response to the recording/reproduction operation mode switching signal, the ECC request count circuit 202 terminates the count operation and outputs the count termination output signal when the total number of output times of the ECC access request that is output from the recording ECC processing circuit 17 reaches 1568.

Then, in response to the count termination signal supplied from the ECC request count circuit 202, the automatic ATAPI/ECC priority switching circuit 201 supplies a priority switching flag output signal “1” designating the priority of the ATAPI access request, to the arbitration circuit 200. Accordingly, in the access arbitration by the arbitration circuit 200, the switching is performed between the lowest priority order and the order higher by one than the lowest, and thus the ECC access request is set at the lowest priority order and the ATAPI access request is set at the order higher by one than the lowest. However, in response to the recording cluster synchronization signal SYNC output subsequently from the modulation circuit 13, because the access arbitration by the arbitration circuit 200 is returned to a usual preset priority order, the state 54 of ATAPI priority is returned to the state 52 of ECC priority.

### <<Various Operation Modes>>

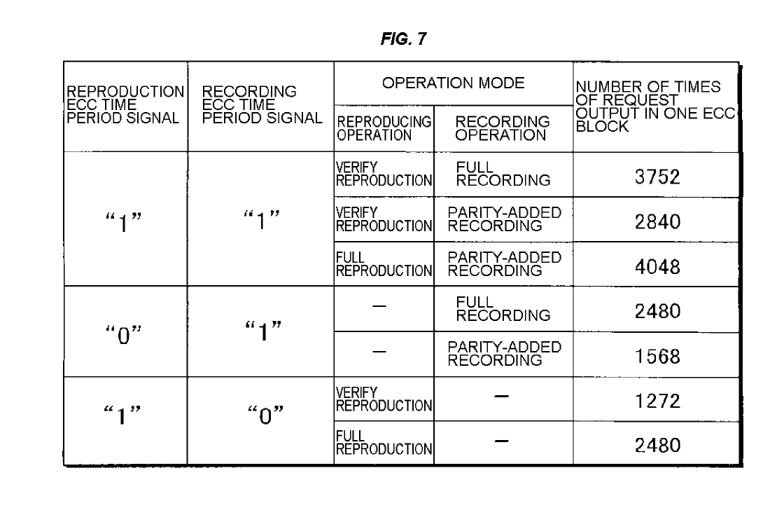

FIG. 7 is a diagram showing a reproduction ECC processing time period signal, a recording ECC processing time period signal, various operation modes of reproduction operations and recording operations, and the number of output times of the ECC access request in one ECC block in the optical disc recording and reproducing semiconductor integrated circuit LSI in accordance with Embodiment 1 of the present invention in FIG. 1.

Three lines of two columns on the left side in FIG. 7, the read-after-write operation show the recording operation and the reproduction operation. In the first line of two columns on the left side in FIG. 7, the reproduction ECC processing time period signal of high level “1” is output from the reproduction ECC processing circuit 18 and, at the same time, the recording ECC processing time period signal of high level “1” is output from the recording ECC processing circuit 17. Accordingly, in response to the reproduction ECC processing time period signal of high level “1” and the recording ECC processing time period signal of high level “1,” the optical disc recording and reproducing semiconductor integrated circuit LSI in accordance with Embodiment 1 of the present invention in FIG. 1 performs the read-after-write operation.

The read-after-write operation has a combination of the verify reproduction and the full recording, that of the verify reproduction and the parity-added recording, and that of the full reproduction and the parity-added recording.

In a read-after-write operation based on the combination of verify reproduction having 1272 output times of the ECC access request and full recording having 2480 output times of the ECC access request, the sum of the two output times becomes 3752.

In a read-after-write operation based on the combination of verify reproduction having 1272 output times of the ECC access request and parity-added recording having 1568 output times of the ECC access request, the sum of the two output times becomes 2480.

In a read-after-write operation based on the combination of full reproduction having 2480 output times of the ECC access request and parity-added recording having 1568 output times of the ECC access request, the sum of the two output times becomes 4048.

In the second line of two columns on the left side in FIG. 7, a reproduction ECC processing time period signal of low level “0” is output from the reproduction ECC processing circuit 18 and, at the same time, a recording ECC processing time period signal of high level “1” is output from the recording ECC processing circuit 17. Accordingly, in response to the reproduction ECC processing time period signal of low level “0” and the recording ECC processing time period signal of high level “1,” the optical disc recording and reproducing semiconductor integrated circuit LSI in accordance with Embodiment 1 of the present invention in FIG. 1 performs a recording operation.

The recording operation has full recording having 2480 output times of the ECC access request and parity-added recording having 1568 output times of the ECC access request.

In the third line of two columns on the left side in FIG. 7, a reproduction ECC processing time period signal of high level “1” is output from the reproduction ECC processing circuit 18 and, at the same time, a recording ECC processing time period signal of low level “0” is output from the recording ECC processing circuit 17. Accordingly, in response to the reproduction ECC processing time period signal of high level “1” and the recording ECC processing time period signal of low level “0,” the optical disc recording and reproducing semiconductor integrated circuit LSI in accordance with Embodiment 1 of the present invention in FIG. 1 performs a reproduction operation.

The reproduction operation has verify reproduction having 1272 output times of the ECC access request and full reproduction of 2480 output times of the ECC access request.

### <<Read-after-Write Operation>>

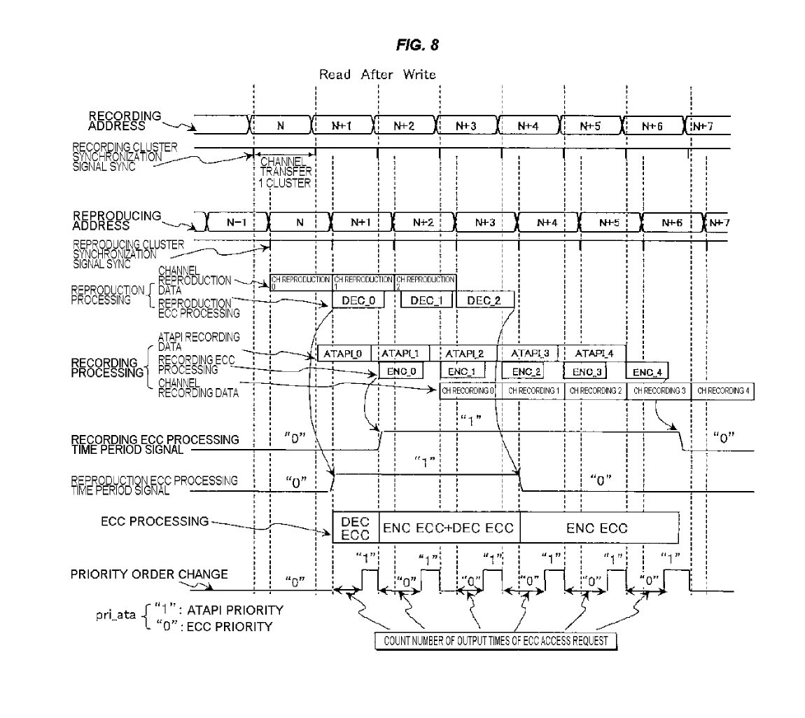

FIG. 8 is a diagram explaining a read-after-write operation being special recording reproduction operation performed in the optical disc recording and reproducing semiconductor integrated circuit LSI in accordance with Embodiment 1 of the present invention in FIG. 1.

The read-after-write operation shown in FIG. 8 is an operation in which writing of data on the optical disc 11 is performed, the recorded data are reproduced immediately after the writing, the reproduced data are compared with the record source data, and after that, new record data are written in the subsequent address.

FIG. 8 shows memory addresses N, N+1, . . . , N+7 being address information of writing data on the optical disc 11. Memory addresses N, N+1, . . . , N+7 are supplied to a pickup drive circuit (not shown) for driving the optical head pickup from the optical disc recording and reproducing semiconductor integrated circuit LSI during the recording operation.

At the timing of head of respective memory addresses N, N+1, . . . , N+7, a recording cluster synchronization signal SYNC indicating the head of recording cluster is supplied to the optical disc recording and reproducing semiconductor integrated circuit LSI from the modulation circuit 13. An drecording cluster includes one ECC block in FIG. 2 and management data such as preamble indicating the head of the recording cluster. During a channel transfer time period between two recording cluster synchronization signals SYNC, one recording cluster is transferred. The channel transfer time period becomes cluster processing time.

FIG. 8 shows reproduction addresses N, N+1, . . . , N+7 being reading address information of data to the optical disc 11 for determination reading. Reproduction addresses N, N+1, . . . , N+7 are supplied to a pickup drive circuit (not shown) for driving the optical head pickup 12 during a reproduction operation from the optical disc recording and reproducing semiconductor integrated circuit LSI.

At the timing of head of respective reproduction addresses N, N+1, . . . , N+7, a reproduction cluster synchronization signal SYNC indicating the head of reproduction cluster is supplied to the optical disc recording and reproducing semiconductor integrated circuit LSI from the demodulation circuit 14.

Record data are read from the optical disc 11 in accordance with reproduction addresses N, N+1, . . . , N+7, and channel reproduction data CH reproduction 0, CH reproduction 1 and CH reproduction 2 generated by the demodulation circuit 14, the deinterleaving circuit 16 and the descrambling circuit are stored one after another in the memory 22 of the SDRAM via the memory control circuit 20. Reproduction data read from the memory 22 of the SDRAM via the memory control circuit 20 is subjected to error correction processing DEC_0, DEC_1, and DEC_2 in the reproduction ECC processing circuit 18. After performing verify processing (comparison processing for determining whether or not reproduction data after error correction by the reproduction ECC processing circuit 18 coincide with the record source data) of reproduction data of recording addresses N, N+1, and N+2, subsequent record data are recorded in recording addresses N+3, N+4, and N+5.

When the reproduction data after the error correction by the reproduction ECC processing circuit 18 by the verify processing of reproduction data of recording addresses N, N+1, and N+2 do not correspond to the record source data, the writing is determined to be a failure, and rewriting is performed. When rewriting is necessary for any of recording addresses N, N+1, and N+2, rewriting is performed while returning to the recording address.

ATAPI record data ATAPI_0, ATAPI_1, ATAPI_2, ATAPI_3, and ATAPI_4 are stored one after another in the memory 22 of the SDRAM via the memory control circuit 20 from the host computer 2 via the Serial-ATAPI interface circuit 19. Record data read from the memory 22 of the SDRAM via the memory control circuit 20 are subjected to recording ECC processing ENC_0, ENC_1, ENC_2, ENC_3, and ENC_4 by the recording ECC processing circuit 17. The record data having been subjected to the recording ECC processing are stored in the memory 22 of the SDRAM via the memory control circuit 20. As a result, channel record data CH recording 0, CH recording 1, CH recording 2, CH recording 3, and CH recording 4 are supplied to the optical head pickup 12 via the interleaving circuit 15 and the modulation circuit 13.

During the time period from the start of the error correction processing DEC_0 of reproduction processing to the termination of the error correction processing DEC_2, the reproduction ECC processing time period signal of high level “1” is supplied to the ECC request count circuit 202 from the reproduction ECC processing circuit 18. And, during the time period from the start of the recording ECC processing ENC_0 of recording processing to the termination of the recording ECC processing ENC_4, the recording ECC processing time period signal of high level “1” is supplied to the ECC request count circuit 202 from the recording ECC processing circuit 17.

As shown in FIG. 8, the high level time period of the recording ECC processing time period signal differs from the high level time period of the reproduction ECC processing time period signal. Accordingly, the ECC processing includes a single processing time period of reproduction ECC processing DECECC alone, a double processing time period of reproduction ECC processing DECECC and recording ECC processing ENCECC, and a single processing time period of recording ECC processing ENCECC.

In the single processing time period of the reproduction ECC processing DECECC alone, as shown in the third line of two columns on the left side in FIG. 7, in verify reproduction, when the ECC access request of 1272 output times is supplied to the ECC request count circuit 202 from the reproduction ECC processing circuit 18, the ECC request count circuit 202 terminates the counting, and, in full reproduction, when the ECC access request of 2480 output times is supplied to the ECC request count circuit 202 from the reproduction ECC processing circuit 18, the ECC request count circuit 202 terminates the counting. Accordingly, by the termination of the counting in the ECC request count circuit 202, the arbitration circuit 200 of the memory control circuit 20 transitions from the state “0” of ECC priority to the state “1” of ATAPI priority. During the time period of the state “0” of ECC priority before the transition, the reproduction ECC processing circuit 18 can access the memory 22 of the SDRAM to perform the error correction processing DEC_0. During the time period of the state “1” of ATAPI priority after the transition, the Serial-ATAPI interface circuit 19 can access the memory 22 of the SDRAM to store the ATAPI record data ATAPI_0 in the memory 22 of the SDRAM. After that, by the recording cluster synchronization signal SYNC at the head of the recording address N+2, the arbitration circuit 200 of the memory control circuit 20 transitions from the state “1” of ATAPI priority to the state “0” of ECC priority.

During the double processing time period of the reproduction ECC processing DECECC and the recording ECC processing ENCECC, as shown in the first line of two columns on the left side in FIG. 7, the ECC access request of 3752 output times in the combination of the verify reproduction and the full recording, or the ECC access request of 2480 output times in the combination of the verify reproduction and the parity-added recording, or the ECC access request of 4048 output times in the combination of the full reproduction and the parity-added recording is supplied to the ECC request count circuit 202 from the recording ECC processing circuit 17 and the reproduction ECC processing circuit 18.

During the double processing time period, first, when the ECC access request of 2480 output times in the full recording, or the ECC access request of 1568 output times in the parity-added recording is supplied to the ECC request count circuit 202 from the recording ECC processing circuit 17, the ECC request count circuit 202 terminates the count operation of the first turn. Accordingly, by the count termination in the ECC request count circuit 202, the arbitration circuit 200 of the memory control circuit 20 transitions from the state “0” of ECC priority to the state “1” of ATAPI priority. During the time period of the state “0” of ECC priority before the transition, the recording ECC processing circuit 17 can access the memory 22 of the SDRAM to perform the recording ECC processing ENC_0. During the time period of the state “1” of ATAPI priority after the transition, the Serial-ATAPI interface circuit 19 can access the memory 22 of the SDRAM to store the ATAPI record data ATAPI_1 in the memory 22 of the SDRAM. After that, by the recording cluster synchronization signal SYNC at the head of the recording address N+3, the arbitration circuit 200 of the memory control circuit 20 transfers from the state “1” of ATAPI priority to the state “0” of ECC priority. Subsequently, when the ECC access request of 1272 output times in the verify reproduction, or the ECC access request of 2480 output times in the full reproduction is supplied to the ECC request count circuit 202 from the reproduction ECC processing circuit 18, the ECC request count circuit 202 terminates the count operation of the second turn. As a result, by the count termination in the ECC request count circuit 202, the arbitration circuit 200 of the memory control circuit 20 transitions from the state “0” of ECC priority to the state “1” of ATAPI priority. During the time period of the state “0” of ECC priority before the transition, the reproduction ECC processing circuit 18 can access the memory 22 of the SDRAM to perform the reproduction ECC processing DEC_1. In the state “1” of ATAPI priority after the transition, the Serial-ATAPI interface circuit 19 accesses the memory 22 of the SDRAM to store the ATAPI record data ATAPI_2 in the memory 22 of the SDRAM. After that, by the recording cluster synchronization signal SYNC at the head of the recording address N+4, the arbitration circuit 200 of the memory control circuit 20 transitions from the state “1” of ATAPI priority to the state “0” of ECC priority.

During the single processing time period of the recording ECC processing ENCECC alone, as shown in the second line of two columns on the left side in FIG. 7, when the ECC access request of 2480 output times in full recording, or the ECC access request of 1568 output times in parity-added recording is supplied to the ECC request count circuit 202 from the recording ECC processing circuit 17, the ECC request count circuit 202 terminates the count operation of the first turn. Accordingly, by the count termination in the ECC request count circuit 202, the arbitration circuit 200 of the memory control circuit 20 transitions from the state “0” of ECC priority to the state “1” of ATAPI priority. During the time period of the state “0” of ECC priority before the transition, the recording ECC processing circuit 17 accesses the memory 22 of the SDRAM to perform the recording ECC processing ENC_1. During the time period of the state “1” of ATAPI priority after the transition, the Serial-ATAPI interface circuit 19 can access the memory 22 of the SDRAM to store the ATAPI record data ATAPI_3 in the memory 22 of the SDRAM. After that, by the recording cluster synchronization signal SYNC at the head of the recording address N+5, the arbitration circuit 200 of the memory control circuit 20 transitions from the state “1” of ATAPI priority to the state “0” of ECC priority. After that, when the ECC access request of 2480 output times in the full recording, or the ECC access request of 1568 output times in the parity-added recording is supplied to the ECC request count circuit 202 from the recording ECC processing circuit 17, the ECC request count circuit 202 terminates the count operation of the second turn. Accordingly, by the count termination in the ECC request count circuit 202, the arbitration circuit 200 of the memory control circuit 20 transitions from the state “0” of ECC priority to the state “1” of ATAPI priority. During the time period of the state “0” of ECC priority before the transition, the recording ECC processing circuit 17 accesses the memory 22 of the SDRAM to perform the recording ECC processing ENC_2. During the time period of the state “1” of ATAPI priority after the transition, the Serial-ATAPI interface circuit 19 can access the memory 22 of the SDRAM to store the ATAPI record data ATAPI_4 in the memory 22 of the SDRAM. Meanwhile, after that, by the recording cluster synchronization signal SYNC at the head of the recording address N+6, the arbitration circuit 200 of the memory control circuit 20 transitions from the state “1” of ATAPI priority to the state “0” of ECC priority. After that, when the ECC access request of 2480 output times in the full recording, or the ECC access request of 1568 output times in the parity-added recording is supplied to the ECC request count circuit 202 from the recording ECC processing circuit 17, the ECC request count circuit 202 terminates the count operation of the third turn. Accordingly, by the count termination of the ECC request count circuit 202, the arbitration circuit 200 of the memory control circuit 20 transitions from the state “0” of ECC priority to the state “1” of ATAPI priority.

In the read-after-write operation in FIG. 8, during the double processing time period of the reproduction ECC processing DECECC and the recording ECC processing ENCECC, the recording ECC processing ENC_0 is performed first in preference to the reproduction ECC processing DEC_1. This is because data of the error correction code of the recording ECC must be generated prior to the generation of an recording cluster to make it possible to write continuously an recording cluster in the optical disc 11, in the system of the optical disc recording and reproducing device 1 in accordance with Embodiment 1 of the present invention in FIG. 1. The reproduction data having been subjected to the error correction processing in the reproduction ECC processing circuit 18 can temporarily be stored in an internal memory such as an SRAM inside the reproduction ECC processing circuit 18, and the Serial-ATAPI interface circuit 19 can be kept waiting for a little time. Therefore, the priority order of the reproduction ECC processing is set to be lower than that of the recording ECC processing.

As described above, the read-after-write operation in FIG. 8 is an operation that switches the number of output times of the ECC access request from the recording ECC processing circuit 17 or the reproduction ECC processing circuit 18 by which the ECC request count circuit 202 terminates the count operation, among the single processing time period of the reproduction ECC processing DECECC alone, the double processing time period of the reproduction ECC processing DECECC and the recording ECC processing ENCECC, and the single processing time period of the recording ECC processing ENCECC alone.

The number of output times of the ECC access request that terminates the count operation of the ECC request count circuit 202, is set by a mode switching signal indicating that the reproduction operation is either verify reproduction or full reproduction, and that the recording operation is either full recording or parity-added recording.

As a result, at the timing of the termination of reproduction ECC processing or recording ECC processing corresponding to one ECC block, the arbitration circuit 200 of the memory control circuit 20 of the optical disc recording and reproducing semiconductor integrated circuit LSI in accordance with Embodiment 1 of the present invention in FIG. 1 is switched from the state of ECC priority to the state of ATAPI priority. Accordingly, during the time period of the ATAPI priority, the access of the Serial-ATAPI interface circuit 19 to the memory 22 of the SDRAM becomes possible. Further, the arbitration circuit 200 of the memory control circuit 20 is switched from the state of ATAPI priority to the state of ECC priority by a signal supplied at an early stage to the ECC request count circuit 202 of the reproduction cluster synchronization signal SYNC from the demodulation circuit 14 and the recording cluster synchronization signal SYNC from the modulation circuit 13.

### Embodiment 2

### Configuration of Another Memory Control Circuit

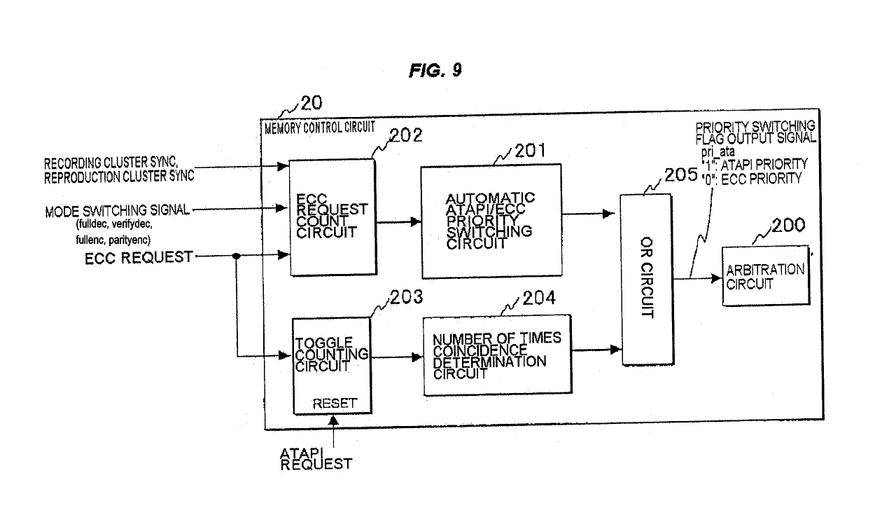

FIG. 9 is a diagram showing the configuration of another memory control circuit 20 incorporated in the optical disc recording and reproducing semiconductor integrated circuit LSI in accordance with Embodiment 2 of the present invention.

The following is the difference of the other memory control circuit 20 in accordance with Embodiment 2 of the present invention in FIG. 9 from the memory control circuit 20 in accordance with Embodiment 1 of the present invention in FIG. 1.

To the other memory control circuit 20 in accordance with Embodiment 2 of the present invention in FIG. 9, a toggle count circuit 203, a number of times coincidence determination circuit 204 and an OR circuit 205 are added, which are not included in the memory control circuit 20 in accordance with Embodiment 1 of the present invention in FIG. 1.

In the other memory control circuit 20 in accordance with Embodiment 2 of the present invention in FIG. 9, the ECC access request supplied to the ECC request count circuit 202 from the recording ECC processing circuit 17 and the reproduction ECC processing circuit 18 is also supplied to an input terminal of the toggle count circuit 203. To a reset terminal of the toggle count circuit 203, the ATAPI request generated from the Serial-ATAPI interface circuit 19 is supplied. A toggle count value generated from an output terminal of the toggle count circuit 203 is supplied to the input terminal of the number of times coincidence determination circuit 204.

The output signal of the automatic ATAPI/ECC priority switching circuit 201 and the output signal of the number of times coincidence determination circuit 204 are supplied to one input terminal of the OR circuit 205 and another input terminal, respectively. A priority switching flag output signal to be supplied to the arbitration circuit 200 from the output terminal of the OR circuit 205 is generated.

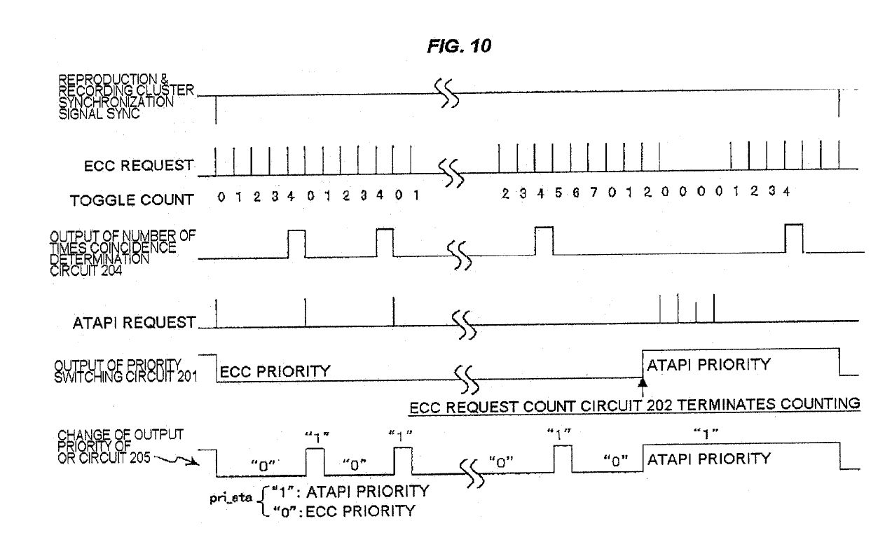

FIG. 10 is a diagram explaining operation of the optical disc recording and reproducing semiconductor integrated circuit LSI in accordance with Embodiment 2 of the present invention incorporating the other memory control circuit 20 in FIG. 9.

As shown in FIG. 10, the toggle count circuit 203 is reset by the ATAPI request supplied to the reset terminal from the Serial-ATAPI interface circuit 19 and the toggle count value of the output terminal becomes zero. The toggle count value is counted up sequentially by the ECC access request supplied sequentially to the input terminal. When the toggle counter 203 is constituted of a 3-bit counter, the counter value is counted up from “0” to “7.”

In FIG. 10, the number of times coincidence determination circuit 204 generates a coincidence determination output signal of a high level in response to such circumstance that the toggle count value of the output terminal of the toggle count circuit 203 becomes a prescribed value “4.”

The prescribed value of the toggle count value is that for setting to be “4” when the ratio of the ECC request per 1 ECC and the ATAPI request is 4:1. Consequently, it becomes possible to terminate the processing of ECC per 1 ECC and the processing of ATAPI at approximately the same timing, and to use effectively the memory 22 of the SDRAM.

As shown in FIG. 10, in response to a signal supplied at an early stage to the ECC request count circuit 202 of the reproduction cluster synchronization signal SYNC and the recording cluster synchronization signal SYNC, the ECC request count circuit 202 is reset to return to the count initial value “0.” In response to the ECC access request supplied sequentially, the ECC request count circuit 202 is counted up, and as the result that the ECC request count circuit 202 terminates the count operation of the ECC access request of a number of output times, specific to operation modes of various operation modes of the recording operation and the reproduction operation, the count termination signal is generated. In response to the count termination signal generated from the ECC request count circuit 202, the output signal of the automatic ATAPI/ECC priority switching circuit 201 is switched from the state of ECC priority of low level “0” to the state of ATAPI priority of high level “1”.

Prior to such circumstance that the ECC request count circuit 202 terminates the count operation and the count termination signal is generated, and that the output signal of the automatic ATAPI/ECC priority switching circuit 201 is switched from the ECC priority state of low level “0” to the ATAPI priority state of high level “1,” a plurality of coincidence determination output signals of a high level is generated from the output terminal of the number of times coincidence determination circuit 204. The plurality of coincidence determination output signals of a high level generated from the output terminal of the number of times coincidence determination circuit 204 is supplied to the arbitration circuit 200 via the other input terminal and output terminal of the OR circuit 205 as a priority switching flag output signal for switching from the ECC priority state to the ATAPI priority state.

In accordance with the optical disc recording and reproducing semiconductor integrated circuit in accordance with Embodiment 2 of the present invention explained referring to FIGS. 9 and 10, it becomes possible to increase the chance of ATAPI priority in the arbitration circuit 200 of the memory control circuit 20, as compared with the embodiment 1 of the present invention explained referring to FIGS. 1 to 8. The increasing level of the chance of the ATAPI priority becomes possible by changing the prescribed value of the toggle count value of the output terminal of the toggle count circuit 203 by which the number of times coincidence determination circuit 204 generates the coincidence determination output signal of a high level.

The invention achieved by the present inventors has been explained specifically based on various embodiments, but, needless to say, the present invention is not limited to that, but it can be changed variously in the range that does not deviate from the gist.

The specific number of times of ECC request signal output by which the ECC request count circuit 202 outputs the count termination signal in operation modes of various operation modes of the recording operation and the reproduction operation can be associated with the number of times of access request to the memory 22 of the SDRAM necessary for the recording operation and the reproduction operation of N ECC blocks of integral multiple, in addition to being associated with the number of access request to the memory 22 of the SDRAM necessary for the recording operation and the reproduction operation of one ECC block.

Moreover, the host interface between the optical disc recording and reproducing semiconductor integrated circuit LSI and the host computer 2 is not limited to the Serial-ATAPI interface circuit 19. As the host interface, in addition to the Serial-ATAPI interface, integrated drive electronics (IDE) and small computer system interface (SCSI) can also be used. And, as the semiconductor memory 22 for use in the optical disc recording and reproducing device 1, a synchronous dynamic random access memory of double data rate (DDR) which is faster than an SDRAM can be used.

What is claimed is:

1. An optical disc recording and reproducing semiconductor integrated circuit that can be incorporated in an optical disc recording and reproducing device performing reproduction operation by reading information from an optical disc and performing a recording operation by writing information on the optical disc,
wherein the optical disc recording and reproducing semiconductor integrated circuit comprises a reproduction error correction processing circuit for the reproduction operation, a recording error correction processing circuit for the recording operation, a host interface circuit connectable to a host apparatus, and a memory control circuit connectable to a semiconductor memory;
wherein the memory control circuit includes an arbitration circuit and a count circuit;
wherein the arbitration circuit is made capable of arbitrating, on the basis of a preset priority order, ECC access request for accessing the semiconductor memory in relation to error correction processing of the reproduction error correction processing circuit and the recording error correction processing circuit, and host interface access request by which a host interface circuit accesses the semiconductor memory in relation to a host interface with the host apparatus;
wherein, in accordance with the preset priority order, the arbitration circuit arbitrates the ECC access request with a priority order higher than that of the host interface access request to make it possible to supply an operation mode signal relating to the reproduction operation and the recording operation to the count circuit;
wherein the count circuit counts the number of output times of the ECC access request that is output from the reproduction error correction processing circuit and the recording error correction processing circuit;
wherein, in response to the fact that the number of output times of the ECC access request, counted by the count circuit coincides with a prescribed number of output times in an operation mode designated by the operation mode signal, the count circuit generates a count termination signal;
wherein the prescribed number of output times corresponds to the number of output times of the ECC access request necessary for accessing the semiconductor memory in relation to data of one ECC block of the optical disc or of an integral multiple of the one ECC block;
wherein, in response to the count termination signal generated from the count circuit, the arbitration circuit performs switching from the preset priority order to the priority order of the access arbitration; and
wherein, in accordance with the priority order of the access arbitration after the switching, the arbitration circuit arbitrates the host interface access request with a priority order higher than that of the ECC access request.

2. The optical disc recording and reproducing semiconductor integrated circuit according to claim 1,
wherein the one ECC block is the smallest unit of the error correction processing of the reproduction error correction processing circuit and the recording error correction processing circuit.

3. The optical disc recording and reproducing semiconductor integrated circuit according to claim 2,
wherein, by the fact that a reproduction signal of a pickup incorporated in the optical disc recording and reproducing device is supplied to a demodulation circuit incorporated in the optical disc recording and reproducing device, reproduction data generated from the demodulation circuit are made capable of being supplied to the reproduction error correction processing circuit;
wherein the reproduction error correction processing circuit is made capable of performing reproduction error correction processing on the reproduction data generated from the demodulation circuit;
wherein the recording error correction processing circuit is made capable of performing recording error correction processing on recording information read from the semiconductor memory via the memory control circuit; and
wherein record data after the recording error correction processing are made capable of being supplied to the pickup via a modulation circuit incorporated in the optical disc recording and reproducing device.

4. The optical disc recording and reproducing semiconductor integrated circuit according to claim 3,
wherein, at the time of the reproduction operation, the count circuit receives a reproduction cluster synchronization signal indicating a head of the one ECC block from the demodulation circuit;
wherein, at the time of the recording operation, the count circuit receives a recording cluster synchronization signal indicating a head of the one ECC block from the modulation circuit; and
wherein the number of output times of the ECC access request, counted by the count circuit is made capable of being reset to a count initial value by a synchronization signal supplied to the count circuit at an early stage of the reproduction cluster synchronization signal and the recording cluster synchronization signal.

5. The optical disc recording and reproducing semiconductor integrated circuit according to claim 4,
wherein, in response to the fact that the count circuit is reset by the synchronization signal supplied at an early stage, the arbitration circuit returns from the priority order of the access arbitration after the switching to the preset priority order.

6. The optical disc recording and reproducing semiconductor integrated circuit according to claim 5, further comprising a central processing unit connected to the memory control circuit,
wherein the central processing unit is made capable of supplying the operation mode signal designating general reproducing and special reproduction as the reproduction operation and general recording and special recording as the recording operation, to the count circuit.

7. The optical disc recording and reproducing semiconductor integrated circuit according to claim 6,
wherein the arbitration circuit is made capable of arbitrating channel access request regarding the reproduction data generated from the demodulation circuit and the record data supplied to the modulation circuit, and CPU access request from the central processing unit.

8. The optical disc recording and reproducing semiconductor integrated circuit according to claim 7,
wherein, in either of the preset priority order and the priority order of the access arbitration after the switching, the arbitration circuit sets the channel access request at the first of both priority orders, the arbitration circuit sets the CPU access request at the second of the both priority orders, and the arbitration circuit sets the ECC request and the host interface access request at the third or lower of the both priority orders.

9. The optical disc recording and reproducing semiconductor integrated circuit according to claim 7,
wherein the semiconductor memory is a dynamic random access memory.

10. The optical disc recording and reproducing semiconductor integrated circuit according to claim 9,
wherein a semiconductor chip of the optical disc recording and reproducing semiconductor integrated circuit, and a semiconductor chip of the dynamic random access memory as the semiconductor memory are incorporated in a single sealing package.

11. An operating method of an optical disc recording and reproducing semiconductor integrated circuit capable of being incorporated in an optical disc recording and reproducing device performing reproduction operation by reading information from an optical disc and performing recording operation by writing information on the optical disc,
wherein the optical disc recording and reproducing semiconductor integrated circuit includes a reproduction error correction processing circuit for the reproduction operation, a recording error correction processing circuit for the recording operation, a host interface circuit connectable to a host apparatus, and a memory control circuit connectable to a semiconductor memory;
wherein the memory control circuit has an arbitration circuit and a count circuit;
wherein the arbitration circuit is made capable of arbitrating, on the basis of a preset priority order, ECC access request for accessing the semiconductor memory in relation to error correction processing of the reproduction error correction processing circuit and the recording error correction processing circuit, and host interface access request by which a host interface circuit accesses the semiconductor memory in relation to a host interface with the host apparatus;
wherein, in accordance with the preset priority order, the arbitration circuit arbitrates the ECC access request with a priority order higher than that of the host interface access request to make it possible to supply an operation mode signal relating to the reproduction operation and the recording operation to the count circuit;
wherein the count circuit counts the number of output times of the ECC access request that is output from the reproduction error correction processing circuit and the recording error correction processing circuit;
wherein, in response to the fact that the number of output times of the ECC access request, counted by the count circuit corresponds to a prescribed number of output times in an operation mode designated by the operation mode signal, the count circuit generates a count termination signal;
wherein the prescribed number of output times corresponds to the number of output times of the ECC access request necessary for accessing the semiconductor memory in relation to data of one ECC block of the optical disc or of an integral multiple of the one ECC block;
wherein, in response to the count termination signal generated from the count circuit, the arbitration circuit performs switching from the preset priority order to the priority order of the access arbitration; and
wherein, in accordance with the priority order of the access arbitration after the switching, the arbitration circuit arbitrates the host interface access request with a priority order higher than that of the ECC access request.

12. The operating method of an optical disc recording and reproducing semiconductor integrated circuit according to claim 11,
wherein the one ECC block is the smallest unit of the error correction processing of the reproduction error correction processing circuit and the recording error correction processing circuit.

13. The operating method of an optical disc recording and reproducing semiconductor integrated circuit according to claim 12,
wherein by supplying a reproduction signal of a pickup incorporated in the optical disc recording and reproducing device, reproduction data generated from the demodulation circuit are made capable of being supplied to the reproduction error correction processing circuit;
wherein the reproduction error correction processing circuit is made capable of performing reproduction error correction processing on the reproduction data generated from the demodulation circuit;
wherein the recording error correction, processing circuit is made capable of performing recording error correction processing on recording information read from the semiconductor memory via the memory control circuit; and
wherein record data after the recording error correction processing are made capable of being supplied to the pickup via a modulation circuit incorporated in the optical disc recording and reproducing device.

14. The operating method of an optical disc recording and reproducing semiconductor integrated circuit according to claim 13,
wherein, in the reproduction operation, the count circuit receives a reproduction cluster synchronization signal indicating a head of the one ECC block from the demodulation circuit;
wherein, in the recording operation, the count circuit receives a recording cluster synchronization signal indicating a head of the one ECC block from the modulation circuit; and
wherein the number of output times of the ECC access request, counted by the count circuit is made capable of being reset to a count initial value by a synchronization signal supplied to the count circuit at an early stage of the reproduction cluster synchronization signal and the recording cluster synchronization signal.

15. The operating method of an optical disc recording and reproducing semiconductor integrated circuit according to claim 14,
wherein, in response to the fact that the count circuit is reset by the synchronization signal supplied at an early stage, the arbitration circuit returns from the priority order of the access arbitration after the switching to the preset priority order.

16. The operating method of an optical disc recording and reproducing semiconductor integrated circuit according to claim 15,
wherein the optical disc recording and reproducing semiconductor integrated circuit further comprises a central processing unit connected to the memory control circuit; and
wherein the central processing unit is made capable of supplying the operation mode signal designating general reproduction and special reproduction as the reproduction operation and general recording and special recording as the recording operation, to the count circuit.

17. The operating method of an optical disc recording and reproducing semiconductor integrated circuit according to claim 16,
wherein the arbitration circuit is made capable of arbitrating channel access request regarding the reproduction data generated from the demodulation circuit and the record data supplied to the modulation circuit, and CPU access request from the central processing unit.

18. The operating method of an optical disc recording and reproducing semiconductor integrated circuit according to claim 17,
wherein, in either of the preset priority order and the priority order of the access arbitration after the switching,
wherein the arbitration circuit sets the channel access request at the first of both priority orders,
wherein the arbitration circuit sets the CPU access request at the second of the both priority orders, and
wherein the arbitration circuit sets the ECC request and the host interface access request at the third or lower of the both priority orders.

19. The operating method of an optical disc recording and reproducing semiconductor integrated circuit according to claim 17,
wherein the semiconductor memory is a dynamic random access memory.

20. The operating method of an optical disc recording and reproducing semiconductor integrated circuit according to claim 19,
wherein a semiconductor chip of the optical disc recording and reproducing semiconductor integrated circuit and a semiconductor chip of the dynamic random access memory as the semiconductor memory are incorporated in a single sealing package.
